(19) United States
(12) Patent Application Publication
(10) Pub. No.: US 2020/0027116 A1
(43) Pub. Date: Jan. 23, 2020

(54) REAL-TIME TRANSACTION CONVERSION FOR POINTS REDEMPTION

(71) Applicant: First Data Corporation, Coral Springs, FL (US)

(72) Inventors: Vijay K. Royyuru, Norristown, PA (US); Lanny Byers, Ridgefield, CT (US); David Farris, Ralston, NE (US); Shawn Kretschmer, Elkhorn, NE (US); Cindy White, Hockessin, DE (US); Skyler Fox, Park Ridge, NJ (US); April Ross, Broomall, PA (US)

(73) Assignee: First Data Corporation, Coral Springs, FL (US)

(21) Appl. No.: 16/517,313

(22) Filed: Jul. 19, 2019

Related U.S. Application Data
(60) Provisional application No. 62/702,078, filed on Jul. 23, 2018.

(51) Int. Cl. G06Q 30/02

(52) U.S. Cl. CPC G06Q 30/0233; G06Q 30/0239

(57) ABSTRACT

Embodiments described herein provide methods and systems for making reward point account balances liquid for the customer. In traditional systems, reward points issued to customers in their reward point accounts have limited redemption options. Embodiments discussed herein allow a user to provision their reward point account into a digital wallet. The user can then use the reward points to purchase goods and services using their reward point account as a payment source via the digital wallet. The result is that the reward point account balance becomes a liquid asset for the customer to use to purchase any goods and/or services at any merchant that accepts payments from a digital wallet. Further, due to real-time point conversion at the time of the transaction, the available point balance is always up-to-date for use through any access method available to the user.

### CROSS REFERENCE TO RELATED APPLICATIONS

This application is a nonprovisional of and claims the benefit of and priority to U.S. Provisional Application No. 62/702,078, filed Jul. 23, 2018, entitled “PAY WITH POINTS AT POINT OF SERVICE,” the content of which is herein incorporated by reference in its entirety for all purposes.

This application is related to co-pending U.S. Utility application Ser. No. 16/517,191, attorney docket number 087188-240010US-1143068, filed Jul. 19, 2019, entitled “PAY WITH POINTS AT POINT OF SERVICE,” the content of which is herein incorporated by reference in its entirety.

### BACKGROUND

Many companies offer loyalty rewards programs for their customers. For example, hotels, credit card companies, airlines, and the like often offer a rewards program. Typically, the loyalty rewards are issued as reward points to the customer in exchange for purchase of goods and/or services from the company. The customer may have the option to redeem the reward points for purchase of the company's goods and/or services on the company's website. In some loyalty reward programs, the customer is required to log into a reward website to select an item and use the rewards points to pay for the selected item. Each item on the reward website may have an associated point reward point cost to purchase the item. Because of the limited ways for customers to use their rewards points, they often go unused. Customers may forget about the reward points and/or forget to log into the redemption website. Some customers may give up before even achieving sufficient rewards to redeem for one of the limited options. These limitations defeat the purpose of the loyalty rewards program because it does not fully foster the loyalty of customers. Further, the rewards points must be maintained on the company's financial records as a liability. Accordingly, a better solution for use of rewards points is needed that will benefit both the customer and the company.

### SUMMARY

A user with a reward point account may wish to utilize that reward point account for purchasing items via any standard payment network such as, for example, STAR or Discover. Embodiments described herein allow a user to provision a reward point account into a digital pay wallet to use as a payment source at any merchant that accepts payment via a digital pay wallet. A method for provisioning the reward point account into a digital wallet may include obtaining an alias primary account number for the reward point account. The alias primary account number may be a sixteen-digit unique number like those used for credit and debit cards. The alias primary account number can be generated by the points bank or by the card management system. The method may include receiving the request to provision the reward point account using the alias primary account number into the digital wallet of the user device. The method may further include authenticating the reward point account with the alias primary account number, tokenizing the alias primary account number to generate a reward point account token, and transmitting the reward point account token to the digital wallet. In subsequent time, a transaction request may be received to authorize payment for a transaction using the reward point account, where the request includes the reward point account token. The token is detokenized to obtain the alias primary account number, and the payment is processed through the point sponsor of the reward point account using the alias primary account number.

The points bank or aggregator may receive the transaction request for the transaction that includes a currency denomination and an account identifier for the reward point account. The account identifier may be the alias primary account number. The transaction currency denomination is converted to a point denomination based on the conversion rule set by the point sponsor for the reward point account. The available point balance for the reward point account is retrieved and used to authorize the transaction request. For example, if there are sufficient available points in the reward point account, the transaction is approved. An authorization (e.g., approval, partial approval, or decline) message is transmitted to a server on the payment network. The points balance in the reward point account is updated in real-time based on the authorization and the transaction point denomination so that the available reward point account balance is always current. For example, if the transaction is approved, the point denomination is deducted from the available reward point account balance.

### BRIEF DESCRIPTION OF THE DRAWINGS

FIG. 1 illustrates an example component architecture for a system used to implement paying with points at a point of service functionality.

FIG. 2 illustrates an example block diagram depicting flow of data for provisioning a reward point account into a digital wallet.

FIG. 3 illustrates an example block diagram depicting flow of data for identifying a balance of a reward point account for display in a digital wallet.

FIG. 4 illustrates an example block diagram depicting flow of data for redeeming points from a reward point account for purchase at a point of service.

FIG. 5 illustrates an example block diagram depicting flow of data for integrating a points bank into a payment processing system for funds settlement.

FIG. 6 illustrates an example swim diagram depicting push provisioning a reward point account into a digital wallet.

FIG. 7 illustrates an example flow diagram for provisioning a reward point account into a digital wallet

FIG. 8 illustrates an exemplary computer system.

FIG. 9 illustrates an exemplary user interface for provisioning a reward point account into a digital wallet.

FIG. 10 illustrates an exemplary user interface of a digital wallet having a reward point account as a payment source.

FIG. 11 illustrates an example flow diagram for real-time transaction conversion.

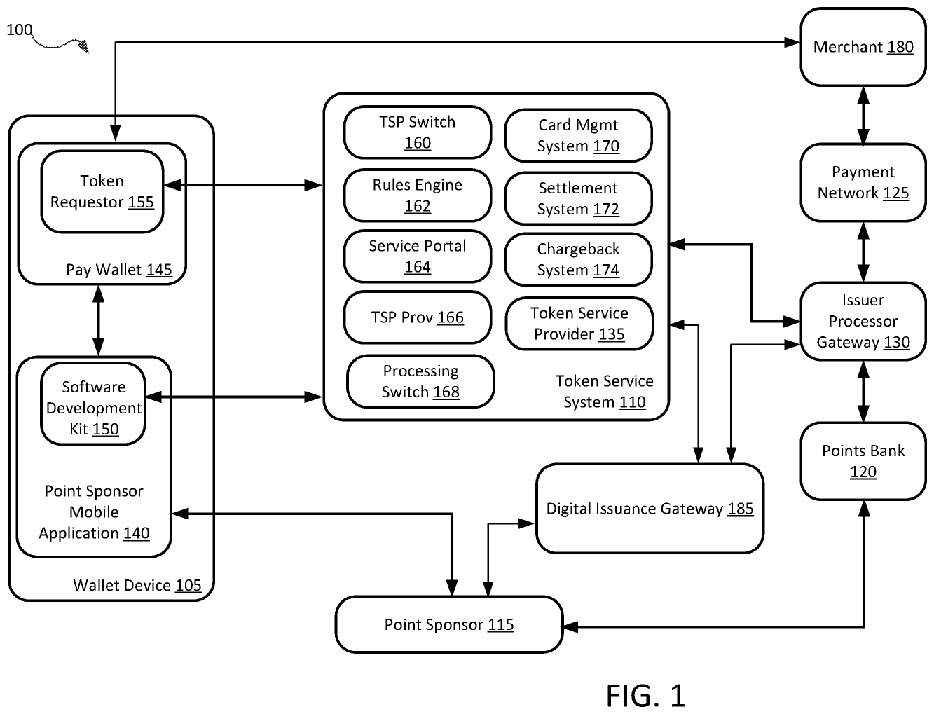

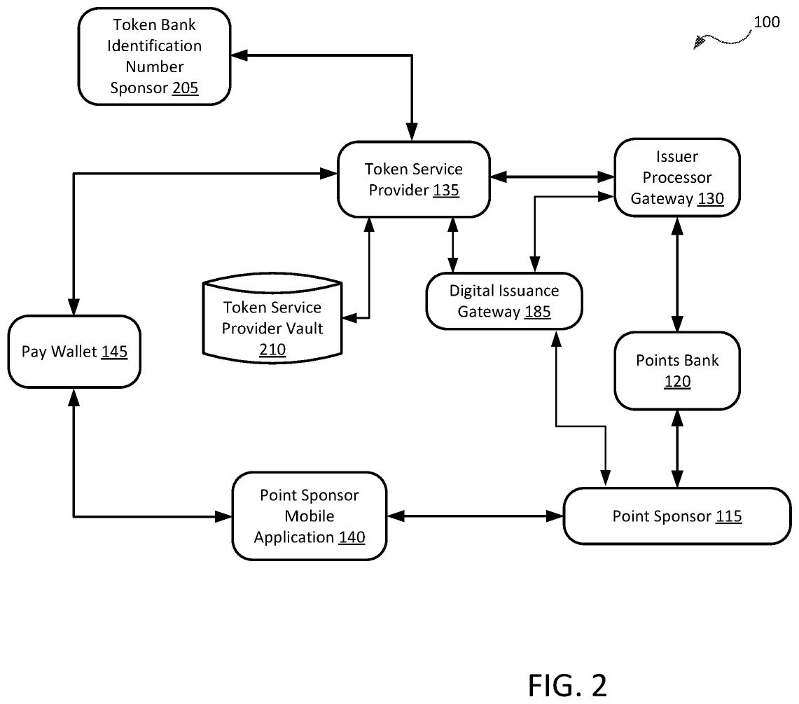

Unless otherwise indicated, elements using the same indicator number are the same elements between differing figures. For example, pay wallet 145 in FIG. 1 is the same pay wallet 145 depicted in FIG. 2.

### DETAILED DESCRIPTION

Embodiments described herein provide methods and systems for making reward point account balances liquid for a customer. In traditional systems, reward points issued to customers in their reward point accounts have limited redemption options. Embodiments discussed herein allow a user to provision their reward point account into a digital wallet. The user can then use the reward points to purchase goods and services using their reward point account as a payment source via the digital wallet. The result is that the reward point account balance becomes a liquid asset for the customer to use to purchase any goods and/or services at any merchant that accepts payments from a digital wallet.

Further embodiments include real-time conversion of the transaction value from a currency denomination to a points denomination and vice-versa. The available points balance for any reward point account is maintained in real-time by a points bank such that the user can access the reward point account available balance at any time by any source including, for example, as a payment method provisioned into a pay wallet or through a reward point catalog of available rewards.

FIG. 1 illustrates an example component architecture for a system 100 that facilitates reward point account provisioning and reward point redemption. System 100 can include wallet device 105, token service system 110, point sponsor 115, points bank 120, issuer processor gateway 130, payment network 125, merchant 180, and digital issuance gateway 185. In some embodiments, system 100 may include more or fewer components than depicted in FIG. 1.

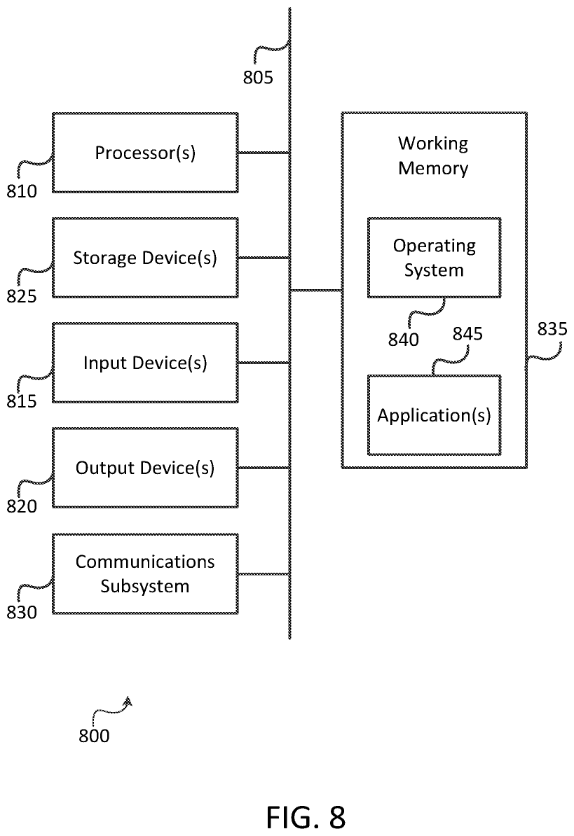

The wallet device 105 may be any suitable device that can support a digital wallet (also referred to herein as a pay wallet). The wallet device 105 may be computer system 800 as described with respect to FIG. 8. The wallet device 105 may be any mobile computing device such as, for example, a mobile cellular telephone, a tablet, a personal digital assistant, or the like. The wallet device 105 (also referred to herein as a user device or a mobile device) may include a pay wallet 145 and point sponsor mobile application 140. While only a single wallet device 105 is depicted in FIG. 1, any number of wallet devices 105 may be supported within system 100.

Pay wallet 145 may be any suitable digital wallet. Pay wallet 145 may be implemented as a software application installed and executed upon the wallet device 105. Currently digital wallets are available from multiple vendors including, for example, Apple Pay® from Apple Inc., Google Pay™ from Google LLC, and Samsung Pay® from Samsung. Pay wallet 145 may include token requestor 155. Token requestor 155 may request a token for the reward point account for use of the reward point account in pay wallet 145 as a payment source. Token requestor 155 may be a software component incorporated into pay wallet 145. Pay wallet 145 may also include other payment sources such as credit cards and bank accounts.

Point sponsor mobile application 140 may be a software user interface application provided by the point sponsor 115. Point sponsor 115 may include, for example, hotels/hotel chains (e.g., Marriott®, IHG®, and so forth), airlines (e.g., United, American Airlines, and so forth), credit card companies (e.g., JPMorgan Chase®, Wells Fargo®, and so forth), merchant stores (e.g., the GAP®, Banana Republic®, and so forth), or any other company that implements a points reward program. Each point sponsor 115 may provide a point sponsor mobile application 140. The point sponsor mobile application 140 may be a software application that is installed on the wallet device 105 and allows the customer to access the customer's reward point account information.

Point sponsor mobile application 140 may incorporate a software development kit 150. The software development kit 150 may provide interfaces and methods for interfacing with pay wallet 145 and token service system 110 that facilitate provisioning of the reward point account as a payment source into the pay wallet 145 for use on the wallet device 105.

Token service system 110 may be the system provided for facilitating provisioning of the reward point account offered by the point sponsor as a payment source into pay wallet 145 and further redemption of the points as payment for goods and services as the payment source in pay wallet 145. Token service system 110 may be one or more computer systems, such as computer system 800 of FIG. 8, that include software and communication interfaces for providing the described functionality. Token service system 110 may include token service provider 135, token service provider switch 160, rules engine 162, service portal 164, token service provider provisioning 166, processing switch 168, card management system 170, settlement system 172, and chargeback system 174. Token service system 110 may include more or fewer components than depicted in FIG. 1 to provide the described functionality.

Token service system 110 may provide the appropriate functionality for interfacing token service provider 135 with pay wallet 145 for each type of pay wallet 145 (e.g., Apple Pay®, Samsung Pay®, Google Pay™, and so forth). Each implementation of a pay wallet 145 may have differing APIs and communication protocols for accessing the token service provider 135.

Token service provider 135 may provide and store tokens representing various payment sources in any given pay wallet 145. For example, a new payment source in pay wallet 145 is provisioned by creating a token representing the account information for that account. The token and account information is stored in a token service provider vault (described in more detail with respect to FIG. 2) which safely stores the information. When the token service provider 135 receives a future request to use the payment source, the payment source may be represented as a token. Token service provider 135 may identify the payment source information from the token service provider vault using the token. In this way, user payment account information is secured and is not transmitted for regular use over the Internet.

Token service provider switch 160 provides functionality for routing transactions from the token service provider 135 to the correct points bank 120 via issuer processor gateway 130. There may be any number of points banks 120 and issuer processor gateways 130. The token service provider switch 160 can provide functionality to determine the correct points bank 120 to communicate with based on the user's account being accessed. For example, if a user's account that has an alias PAN is being accessed, the token service provider switch 160 can determine which points bank 120 is correct based on the alias PAN and determine the correct issuer processor gateway 130 based on the points bank 120 to communicate through.

Rules engine 162 is responsible for enforcing the rules for provisioning a point account into a pay wallet 145. For example, the rules may include requiring specific authentication of the user, requiring specific encryption types or strengths of the token, and the like.

Service portal 164 provides an interface for administrators to configure portions of the token service system 110. For example, an administrator may access the token service system 110 through the service portal 164 to add a rule to the rules engine 162.

Token service provider provisioning 166 provides functionality for provisioning a new token with the token requestor 155.

Processing switch 168 provides functionality for routing transactions between payment networks 125 and issuer processor gateways 130.

Card management system 170 provides functionality for managing the card the user has provisioned into the pay wallet 145.

Settlement system 172 provides functionality for settling currency denominated transactions between the payment networks 125 and the points sponsor 115.

Chargeback system 174 provides functionality for crediting currency denominated transactions back to the points sponsor's 115 settlement account when the user returns an item or disputes a charge.

Points bank 120 may be any suitable provider of reward point account point banking. Points banks 120 manage the points for point sponsor 115 for each customer's reward point account. For example, point sponsor 115 may offer a reward point loyalty program, and points bank 120 may manage each customer's available points, credits to the customer's point balance as determined by the point sponsor, debits from the customer's point balance for redemption of the customer's reward points, and so forth. Several companies offer point bank services, and there are many white label points banks 120 currently available and used by point sponsors 115. Known points banks 120 are commonly referred to as white label point banks. While a single points bank 120 is shown in FIG. 1 for ease of description and readability, many points banks 120 may be included in system 100 for managing points for any number of point sponsors 115. FIG. 1 also depicts a single point sponsor 115 for ease of description and readability, however many point sponsors 115 may be included in system 100.

Issuer processor gateway 130 may be any suitable processor that processes payments for accounts made by the bank that backs the reward point account for the point sponsor 115. Payment network 125 may be any suitable payment network such as Discover®, STAR®, and so forth. Payment network 125 may require that a bank back the point sponsor 115 to incur the liability in the event that point sponsor 115 does not pay for customer point redemption as needed. For that reason, a bank (the “backing bank”) that backs the point sponsor 115 may allow payment network 125 to process transactions using issuer processor gateway 130. Use of payment network 125 allows any merchant point of service device that processes payments over the payment network 125 to accept the point reward account as a payment source without special implementation of software or other systems by the merchant. Note that when the transaction settlement is performed (transaction settlement is a typical process for credit and debit card transactions), the payment network 125 may settle funds with the points sponsor 115. However, if the points sponsor 115 fails to meet the settlement obligations, the payment network 125 may hold the backing bank liable for the transaction. While a single issuer processor gateway 130 is shown in FIG. 1 for ease of description and readability, many issuer processor gateways 130 may be included in system 100 because many banks may back reward point accounts for any number of point sponsors 115.

Merchant 180 may be any merchant at which the user of the wallet device 105 finds goods or products to purchase that accept a pay wallet 145 form of payment. While only one merchant 180 is shown for simplicity, any number of merchants 180 may accept payment from the payment network 125. When the user makes payment to the merchant 180 using the pay wallet 145, the payment network 125 makes payment to the merchant 180 using national currency (e.g., United States dollars) which has been converted from the points owned by the user of the wallet device 105.

Digital issuance gateway 185 interfaces between the token service provider 135, the issuer processor gateway 130, and the point sponsor 115 to provide account number lookup and encryption services.

In use, point sponsor 115 may offer a reward point account to a customer. The customer may have wallet device 105 and may access point sponsor mobile application 140 on wallet device 105. Wallet device 105 may further include pay wallet 145 that the customer uses to store and access payment methods (e.g., debit and credit cards) for purchasing goods and services at merchant 180. Within point sponsor mobile application 140, a software development kit 150 resides that may be used to provide a button or link in the point sponsor mobile application 140 that, when pressed, begins the provisioning process of adding the reward point account from point sponsor 115 into the pay wallet 145 as a payment source. Details of how the software development kit 150 incorporates the button in the point sponsor mobile application are described in U.S. Provisional Application No. 62/686,369, entitled INSTANT DIGITAL ISSUANCE, filed Jun. 18, 2018, (“Instant Digital Issuance”) and U.S. patent application Ser. No. 16/443,169, entitled INSTANT DIGITAL ISSUANCE, filed Jun. 17, 2019 (“IDI 2”) which are each incorporated by reference herein for all purposes. Further details of the process of provisioning a point account into pay wallet 145 are described with respect to the following figures.

FIG. 2 illustrates portions of system 100 for use in describing the enrollment flow when the customer selects the button or link to add the reward point account to pay wallet 145 from the point sponsor mobile application 140.

Initially, the points bank 120 may generate an alias primary account number (PAN) for the reward point account. Alternatively, the card management system 170 may generate the alias PAN for the rewards point account upon receiving a request from the points sponsor 115 via the digital issuance gateway 185. Note that the issuer processor gateway 130 may be the processor that processes payments for the backing bank as described above. Issuer processor gateway 130 and/or the backing bank may have an associated token bank identification number (BIN) which is associated with the backing bank. The backing bank is depicted in FIG. 2 as token BIN sponsor 205. The known BIN from the token BIN sponsor 205 may be used on the payment network 125. Points bank 120 may use the known BIN to generate the alias PAN for the reward point account. Payments processed on a payment network 125 may be from accounts that have a PAN of 16 digits where the first 6 digits may be the BIN. Points bank 120 may generate the alias PAN using the BIN as the first 6 digits. Points bank 120 may communicate the alias PAN to the token BIN sponsor 205 to ensure that the alias PAN is not used as an account number for a new account at token BIN sponsor 205. Points bank 120 may further communicate the alias PAN to the point sponsor 115, and the alias PAN may be used by the point sponsor mobile application 140 to generate the button or link to add the reward point account to pay wallet 145 as described in Instant Digital Issuance and IDI 2.

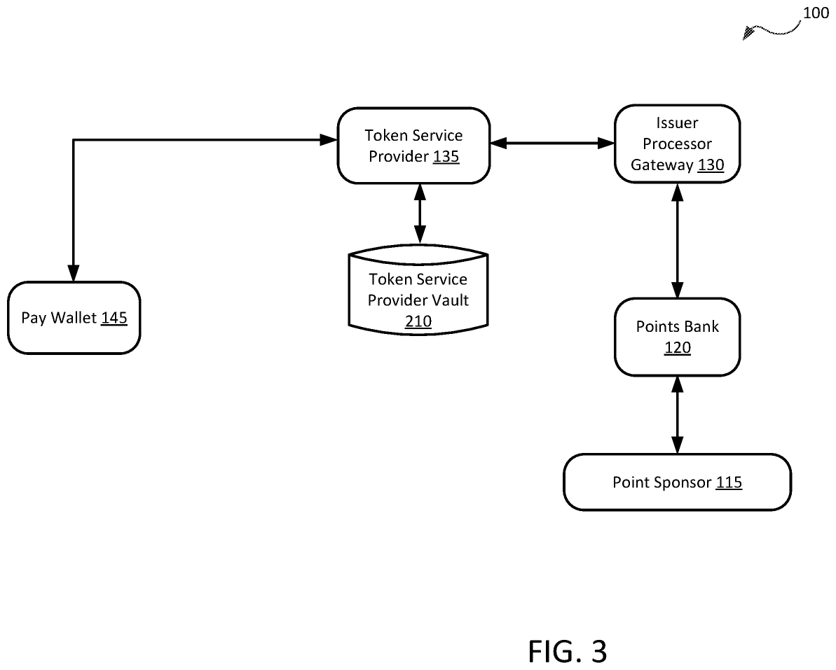

Once the user (i.e., customer) presses the button or clicks the link in the point sponsor mobile application 140 to provision the reward point account into pay wallet 145, the software development kit 150 adds pay wallet data to the provision request and sends it to the digital issuance gateway 185. The digital issuance gateway 185 assigns the alias PAN to the reward account information, via the card management system 170, and returns an encrypted PAN to the point sponsor 115. Upon receiving the encrypted PAN, the software development kit 150 communicates with pay wallet 145 to provide the request and the encrypted PAN. Pay wallet 145 may transmit the provision request including the encrypted PAN to token service provider 135 to obtain a token representing the reward point account so that the reward point account can be provisioned into the pay wallet 145. Token service provider 135 may transmit the provision request with the encrypted PAN to the issuer processor gateway 130 to obtain reward point account information and authenticate the reward point account as associated with the customer. Issuer processor gateway 130 may communicate with points bank 120 to obtain authentication of the customer reward point account with the encrypted PAN. Points bank 120 may authenticate the customer reward point account with the encrypted PAN and return the authorization to the issuer processor gateway 130. The issuer processor gateway 130 may forward the authorization to the token service provider 135. Once token service provider 130 has the authorization, token service provider 135 may generate a reward account token for the alias PAN. The reward point account token is generated based on the associated payment network 125 used to process the reward point account payments. For example, the Discover® payment network may agree to process the payments made using the reward point accounts based on the backing bank and the issuer processor gateway 130. Token service provider 135 may use the payment network 125 information to generate the reward point account token. Token service provider 135 may transmit the reward account token to pay wallet 145, which may then display the alias PAN as a funding source within pay wallet 145 and use the reward account token for redemption as described with respect to FIG. 3.

Additionally, the reward account token, the reward account information, and the alias PAN may be stored in association in the token service provider vault 210. The token service provider vault 210 may be a secure database containing account information, including the PAN for each associated account number.

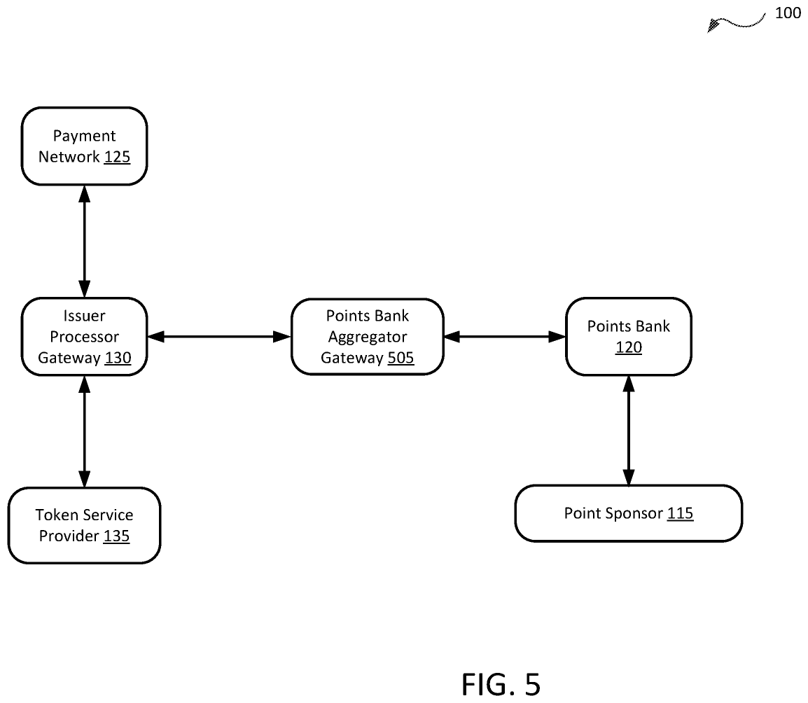

In some embodiments, token service provider 135 may transmit the reward account token to issuer processor gateway 130, points bank 120, and point sponsor 115 in addition to transmitting the reward account token to the pay wallet 145. In some embodiments, a bridging solution may be included that provides point sponsor aggregation functionality, also called a white label reward point company herein. A white label reward point company is depicted as points bank aggregator gateway 505 and described with respect to FIG. 5. As shown in FIG. 5, the bridging solution may be inserted between the point sponsor and other components of the system 100.

The provisioning described herein is referred to as push provisioning. The authentication and encryption services provided by the token service system 110 and communications between the various components used for push provisioning are described in Instant Digital Issuance and IDI 2.

In addition to enabling a reward account for use in a pay wallet 145, the user may close the reward account. For example, the user may stop using the point sponsor 115 for purchases such that all points are forfeited creating an implied closure, or the user may actively close the reward account. When the point sponsor 115 determines that the user has closed his or her reward account, the point sponsor 115 sends a close message to the digital issuance gateway 185. The digital issuance gateway 185 will remove the reward account and associated alias PAN from the digital issuance gateway 185 data store and will notify the token service provider 135 that the reward account is closed. The token service provider 135 will notify the pay wallet 145, which removes the reward account and alias PAN from the pay wallet 145. The card management system 170 will also be updated to mark the account with the alias PAN as closed.

FIG. 3 illustrates portions of system 100 for use in describing the balance flow, which allows the pay wallet 145 to display the balance of the reward point account. There are two methods that may be used. In some embodiments, the balance is requested by the pay wallet 145. In other embodiments, the points bank 120 may push the balance to the pay wallet 145 when the balance changes.

For embodiments in which the balance is requested, a getBalance application programming interface (API) is used. Pay wallet 145 may support the getBalance API. Pay wallet 145 requests the balance of the reward point account from the token service provider 135 using the getBalance API. The getBalance API allows the pay wallet 145 to send the token information for which the balance is requested. The token service provider 135 detokenizes the token to identify the alias PAN in the token service provider vault 210. Once the token service provider 135 has detokenized the token, the token service provider 135 obtains the alias PAN. In some embodiments, the alias PAN may be included in the getBalance API request. Token service provider 135 sends a balance inquiry with the alias PAN to issuer processor gateway 130. The issuer processor gateway 130 transmits a balance inquiry message (e.g., a “0200” message) with the alias PAN to the points bank 120. Points bank 120 may have the points balance or, in some embodiments, may request the points balance from the points sponsor 115. Once the points bank 120 has the points balance of points, the points bank 120 converts the points into a monetary value based on the points sponsor 115 rules. For example, a customer having a points balance of fifty thousand (50,000) points may convert to fifty dollars ($50.00) for a points sponsor having rules that one thousand (1,000) points equals one dollar ($1.00). The points bank 120 may convert the points into a monetary value and provide the monetary value of the points balance and/or the points balance to the issuer processor gateway 130 in response to the balance inquiry message using a balance inquiry response (e.g., “0210” response). The issuer processor gateway 130 may forward the balance inquiry response including the monetary value and/or the points balance to the token service provider 135. Token service provider 135 generates and transmits a getBalance response to pay wallet 145 with the monetary value and/or the points balance. Once the pay wallet 145 receives the response to the getBalance API request, the pay wallet 145 displays the updated points balance and/or monetary value to the user in the pay wallet 145 user interface.

In embodiments including a pay wallet 145 that does not support the getBalance API, the points bank 120 may push the balance to the pay wallet 145 when the reward account balance changes. The points bank 120 may identify that the reward account balance changes. Using the alias PAN, the points bank 120 transmits a push notification (e.g., “0302” notification) to the issuer processor gateway 130 with the alias PAN and the reward point account balance of points and/or the associated monetary value of the points. The issuer processor gateway 130 forwards the push notification to the token service provider 135. The token service provider forwards the push notification to the pay wallet 145. The pay wallet displays the balance as a message, for example, under the card image in the user interface of the pay wallet 145.

Note that in some embodiments the point balance for the reward point account is maintained by the points bank 120 at all times. By maintaining the point balance at the point bank 120 and performing a conversion of points into a monetary value based on the point sponsor rules at each transaction (e.g., authorization for payment, balance inquiry, and so forth), the points balance is available to the customer for use in any way at all times. For example, if the user would like to use the points with the provisioned alias PAN in the user's digital wallet at a brick and mortar merchant, the user may do so. The transaction will deplete the user's point balance at the time of the transaction with a standard pending transaction procedure that puts a hold on the points. When the transaction clears during settlement by the payment network, the points balance depletion is complete. Additionally, if the customer returns the goods or disputes the service, the points may be added back into the customer's points balance at the points bank 120. Further, if the user would like to use the points in the reward point account for purchase on a reward catalog that the points sponsor 115 may offer, the user may do that at any time. The availability of all points at any time at any merchant is facilitated by the conversion of points happening only at the point and time of the transaction.

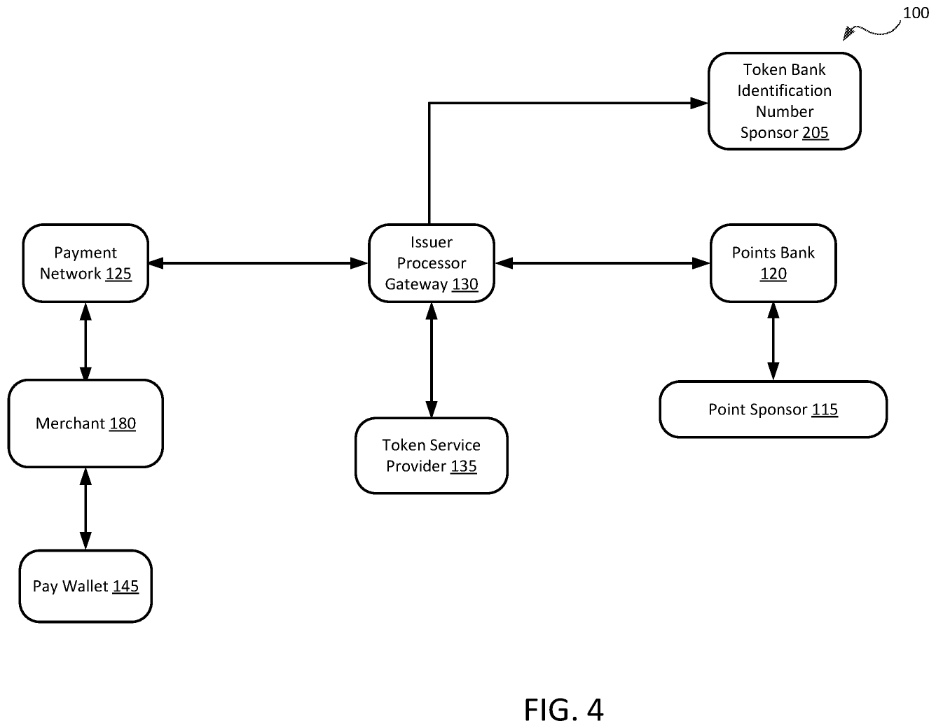

FIG. 4 illustrates portions of system 100 for use in describing the redemption flow for using the reward point account in the pay wallet 145 as a payment source for goods and/or services at a merchant 180. The customer may use the reward point account in the pay wallet 145 to pay for goods and/or services at the point of sale device at merchant 180 (i.e., a payment transaction). For example, the user may hold the wallet device 105 near the point of sale device. The wallet device 105 may use near field communication (NFC) to transmit the payment request using pay wallet 145 and specifically the provisioned reward point account as the payment source. Merchant 180 may process the payment transaction through the payment network 125 by providing the token and payment amount. The payment network 125 may request processing of the payment by the issuer processor gateway 130. The issuer processor gateway 130 may send the token to the token service provider 135 for detokenization, validation, and domain checking. The token service provider 135 can detokenize the token to obtain the alias PAN using the token service provider vault 210 and provide the alias PAN to the issuer processor gateway 130. The issuer processor gateway 130 may transmit an authorization request to the points bank 120. The points bank 120 may validate that the customer has sufficient points in their point reward account and authorize the payment. In some embodiments, the points bank 120 may obtain authorization and/or validation from the points sponsor 115. Once the payment is authorized, the points bank 120 may transmit the settlement information, including fee amounts, to the issuer processor gateway 130. In some embodiments, if the full payment is not authorized, a partial authorization or a decline message may be transmitted. Issuer processor gateway 130 may transmit the authorization (if obtained) over payment network 125 to the merchant 180 for completion of the sale. Issuer processor gateway 130 may also transmit the fee information to the token BIN sponsor 205.

As described above, the redemption of points from a reward point account to purchase goods and services may flow much like the process of authorizing payment for goods and services from a credit card company. One distinction is that the points bank 120 may be a white label reward point company that manages the reward points for other companies that have loyalty reward programs. When the issuer processor gateway 130 authorizes the payment, instead of requesting the authorization from a financial banking institution as in a credit card transaction, the issuer processor gateway 130 authorizes the payment with the points bank 120. Note that like other payment sources, some embodiments allow for partial allowances and the like for authorizations in which the customer may not have enough funds (points) to pay for the good or service. Rather than a simple decline of the transaction (called a hard decline), the points bank may authorize payment up to the points balance of the customer in the reward point account associated with the alias PAN. The authorization process happens very quickly, which is considered in real-time, just as a standard transaction with a credit card (i.e., a credit card or a debit card) is authorized immediately when a customer swipes the credit card at a point of sale device or uses a credit card in a digital wallet at a point of sale device.

Note further that the use of the alias PAN and reward account token as described herein allow the use of the payment network 125. The payment network 125 may be any open loop payment network (such as Discover or STAR). Because these payment networks are accepted at virtually every merchant, the customer's reward point account balance may be redeemable at virtually any merchant.

FIG. 5 illustrates portions of system 100 for use in describing the integration of the points bank 120 in more detail. When a user requests the use of the reward point account as the payment source at a merchant, the payment network 125 may facilitate processing the payment by transmitting the request to the issuer processor gateway 130 as described in FIG. 4. When the issuer processor gateway 130 requests the authorization from the points bank 120, the issuer processor gateway 130 transmits a message to the points bank 120 using the payment network 125 for handling the real-time authorization, daily settlement, and monthly fees. The message is routed to the proper destination by points bank aggregator gateway 505. Points bank aggregator gateway 505 is responsible for routing transactions over the correct payment network 125 to and from the token service provider 135 to and from the points bank 120. For STAR and Discover payment networks, ISO 8583 is used for the real-time authorization, daily settlement, monthly fees which are routed by points bank aggregator gateway 505. That communication propagates to the points bank 120 for real-time authorization when a merchant processes a payment using the reward point account in the customer's pay wallet 145. The points bank 120 may provide the authorization, accept settlement, and provide point conversion to monetary values back to the issuer processor gateway 130 using points bank aggregator gateway 505. In some embodiments, the points bank aggregator gateway 505 acts as an issuer processor. The points bank aggregator gateway 505 may receive purchase transaction authorization requests from issuer processor gateway 130 in currency denominations. The points bank aggregator gateway 505 may convert the currency denomination value to points denomination value according to the conversion rules established by the points sponsor 115. Once the points bank aggregator gateway 505 has the point denomination value for the transaction, the points bank aggregator gateway 505 may request the points balance for the user's reward point account from the points bank 120. The points bank aggregator gateway 505 can determine whether the user's reward point account has sufficient points to authorize the transaction. In some embodiments, the points bank aggregator gateway 505 may provide partial authorization based on the user's point balance if it is insufficient to cover the entire transaction amount. The points bank aggregator gateway 505 can send a full or partial authorization or a denial of the transaction request to the issuer processor gateway 130 in a currency denomination. The points bank aggregator gateway 505 can also send an update to the points bank 120 with the updated points amount for the user's point account based on any authorization made. As an example, the transaction request from issuer processor gateway 130 may be for $10, and the points bank 120 may provide a points balance of two hundred and twenty (220) points to the points bank aggregator gateway 505. The point sponsor 115 rules for the reward point account may be that each point is worth ten cents ($.10). The points bank aggregator gateway 505 can determine that the user has a currency denomination available of twenty-two dollars ($22.00). The points bank aggregator gateway 505 can send an authorization for the ten dollar transaction to the issuer processor gateway 130 and send a point balance update for the user's reward point account to the points bank 120. The point balance update for the transaction may be that the points balance should be reduced by one hundred (100) points and/or that the updated reward point account balance is one hundred twenty (120) points based on the pending transaction. Points bank 120 can put a hold on one hundred (100) points of the user's point balance until the transaction settlement clears. Once the transaction settlement occurs, the user's reward point balance will be one hundred twenty (120) points and the one hundred held points will be removed.

In embodiments including a points bank aggregator gateway 505 that provides point conversion, the point balance for the reward point account is maintained by the points bank 120 at all times. The points bank aggregator gateway 505 may perform transaction authorization for any type of transaction instead of the points bank 120 directly authorizing the transaction, but at the time of the transaction the points bank aggregator gateway 505 sends a point balance update to the points bank 120 to modify the point balance for the reward account being used. The conversion of points into a monetary value based on the point sponsor rules at each transaction (e.g., authorization for payment, balance inquiry, and so forth) is completed by the points bank aggregator gateway 505, and the points balance is available to the customer for use in any way at all times because the point balance for the reward point account is maintained by the points bank 120. The points bank aggregator gateway 505 queries the points bank 120 for the current balance before authorizing a transaction, so the current points balance for a user's reward account is known at the time of the transaction. Since the authorization and conversion happens at the points bank aggregator gateway 505, the points balance is always current for each user as reported by the points bank 120. As such, it does not matter whether a points bank aggregator gateway 505 performs denomination conversion and/or authorizes transactions for the points bank 120 or if the points bank 120 performs denomination conversion and/or authorizes transactions as described previously because the responsible party will always have access to the current point balance for each user. For example, if the user would like to use the points with the provisioned alias PAN in the user's digital wallet at a brick and mortar merchant, the user may do so. The transaction will deplete the user's point balance at the time of the transaction with a standard pending transaction procedure that puts a hold on the points at the points bank 120. The points bank aggregator gateway 505 converts the points denomination into a currency denomination for the issuer processor gateway 130 to utilize and the points bank 120 uses the points denomination to deplete the user's point balance at the time of authorization of the transaction, which is provided by the points bank aggregator gateway 505. When the transaction clears during settlement by the payment network 125, the points balance depletion is complete. Additionally, if the customer returns the goods or disputes the service, the points may be added back into the customer's points balance at the points bank 120 via the points bank aggregator gateway 505. The points bank aggregator gateway 505 performs the conversion of currency denomination to points denomination based on the point sponsor rules and provides the points denomination to the points bank 120 for updating the user's reward point account balance. Further, if the user would like to use the points in the reward point account for purchase on a reward catalog that the points sponsor 115 may offer, the user may do that at any time. The availability of all points at any time at any merchant is facilitated by the conversion of points happening only at the point and time of the transaction.

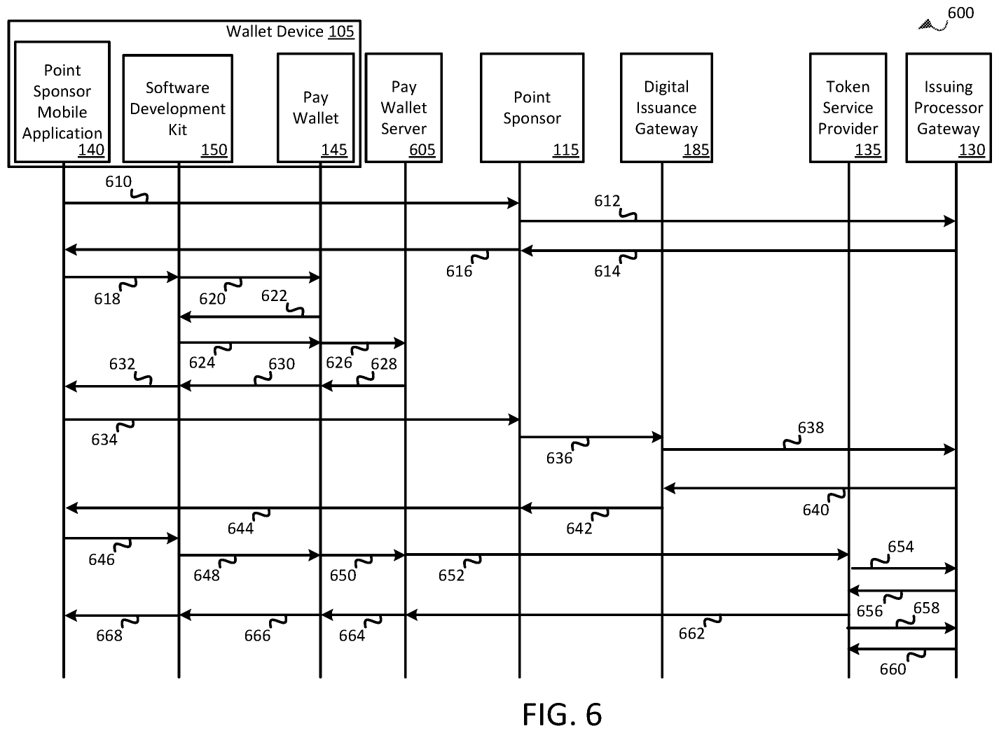

FIG. 6 illustrates a swim diagram 600 of a method for instant digital issuance of a reward point account using the components described with respect to FIG. 1. Some components described with respect to FIG. 1 are shown along the top of the swim diagram 600, including the wallet device 105, point sponsor mobile application 140, software development kit 150, pay wallet 145, point sponsor 115, digital issuance gateway 185, token service provider 135, and issuing processor gateway 130. Also depicted is pay wallet server 605, which is the server used to support the pay wallet 145 on the wallet device 105.

Beginning with the point sponsor mobile application 140, as shown by arrow 610, the point sponsor mobile application 140 transmits user information entered by the user using the user interface of the point sponsor mobile application 140. The user information is transmitted to the point sponsor 115.

The point sponsor 115 may authenticate the user using the user information (e.g., a user name and password, biometric data, and so forth). The point sponsor 115 may transmit a request, shown by arrow 612, to issuing processor gateway 130 for a list of eligible accounts for the user. The eligible accounts may include any user accounts the issuer has recorded for the user that is available for that point sponsor 115. For example, a user may have one or more reward accounts that are backed by a backing bank associated with the same issuer (e.g., Wells Fargo, Capital One, and so forth) for which an alias PAN has been generated.

The issuing processor gateway 130 may transmit the PAN suffix data (e.g., the last four digits of the sixteen digit account number) for each eligible account for the user to the point sponsor 115 as shown by arrow 614. As previously described, an alias PAN may be generated for each rewards point accounts having a backing bank from the issuing processor gateway 130. The point sponsor 115 may transmit the PAN suffix data to the point sponsor mobile application 140 as shown by arrow 616. The point sponsor mobile application 140 may not maintain account information for the user on the wallet device 105, so all account information may be obtained from the point sponsor 115 for display in the user interface of the point sponsor mobile application 140.

Once the point sponsor mobile application 140 has obtained the PAN suffix data, the point sponsor mobile application 140 can invoke methods provided by the software development kit 150 as shown by arrow 626. Arrow 620 indicates that the software development kit 150 may include a method to query the pay wallet 145 for whether the PAN suffix data identifies an account (i.e., rewards account payment source) that has previously been provisioned by the pay wallet 145. If the account has previously been provisioned by the pay wallet 145, there is no need to provision the account again. However, if the account has not previously been provisioned by the pay wallet 145, the user may wish to use push provisioning to provision the pay source into the pay wallet 145.

The pay wallet 145 may respond to the query, as shown by arrow 622, with information indicating whether the account associated with the PAN suffix data for each eligible account has previously been provisioned.

If at least one account has not previously been provisioned, the software development kit 150 may invoke another method to request wallet data for push provisioning. Wallet data may include, for example, a wallet identifier (i.e., an identifier for pay wallet 145), a device identifier (e.g., an Internet Protocol address for wallet device 105, a media access control (“MAC”) address for wallet device 105, or any other suitable identifier for wallet device 105), a binding identifier or a digital signature that binds the user to the pay wallet 145, a name of the wallet device 105, the push provision request (used to prevent the request from being replayed or spoofed), a wallet certificate that contains a public key for encrypting PAN data to be sent back to the pay wallet server 605, and the like. For simplicity of explanation, only a single account provision is described, but multiple accounts from an issuer may be provisioned into pay wallet 145 in parallel or serially. The software development kit 150 may request the wallet data from the pay wallet 145 as shown by arrow 624. The pay wallet 145 may request the wallet data from the pay wallet server 605 as shown by arrow 626. The pay wallet server 605 may provide the wallet data for the account to the pay wallet 145 as shown by arrow 628. The pay wallet 145 may provide the wallet data to the software development kit as shown by arrow 630. The software development kit 150 may provide the wallet data to the point sponsor mobile application 140 as shown by arrow 632. The point sponsor mobile application 140 may then display a button within the user interface of the point sponsor mobile application 140. The button, when pressed by the user, may invoke the push provisioning process for adding the account to the pay wallet 145.

Arrow 634 may transmit the wallet data from the point sponsor mobile application 140 to the point sponsor 115 when the user pushes the button within the point sponsor mobile application 140 to invoke the push provisioning process for adding the payment source (i.e., eligible account for which the PAN suffix data was obtained) to the pay wallet 145.

The point sponsor 115 may authenticate the user and confirm the authenticity of the received information. Once authenticated, the point sponsor 115 may provide the account information (e.g., the user name, the PAN suffix data, and so forth), the wallet data, and an issuer nonce to the Digital issuance gateway 185 as shown by arrow 636. The issuer nonce may be a randomly generated identifier that indicates that the user has been authenticated by the point sponsor 115 (the user was previously authenticated at arrow 610) and is used in the push provision request for the transaction beginning at arrow 636. Optionally, the PAN data including the full sixteen digit account number may have been provided to the digital issuance gateway 185 from the point sponsor 115 as well.

The digital issuance gateway 185 may determine whether a full PAN lookup is needed based on whether the digital issuance gateway 185 has the PAN data. If the digital issuance gateway 185 does not have the PAN data, the digital issuance gateway 185 may request the PAN data from the issuing processor gateway 130 as shown by arrow 638. The request may include the user information, account information, and/or credentials obtained from the point sponsor 115. The issuing processor gateway 130 may search a database or other data source using the user information, account information, and/or credentials to identify the requested PAN data. The issuing processor gateway 130 may return the PAN data to the digital issuance gateway 185 as shown by arrow 640. The PAN data may include the full sixteen digit account number, the user's address, and/or the payment source (e.g., reward account) nickname.

The digital issuance gateway 185 may encrypt the PAN data to create encrypted provision data. Optionally, the user information, account information, wallet data, issuer nonce, PAN data, user's address, and/or card nickname may be included with the PAN data and encrypted. The digital issuance gateway 185 may encrypt the PAN data (including the user information, account information, wallet data, issuer nonce, PAN data, user's address, and/or card nickname) using an encryption key and may digitally sign the PAN data using a validation key. The encryption key and/or the validation key may be set with the token service provider information. In other words, the encryption key and/or the validation key may identify the token service provider 135. The encryption key and/or the validation key may be obtained from the issuer when the issuer registers with the digital issuance gateway 185. Optionally, the encryption key and/or the validation key may be established directly between the digital issuance gateway 185 and the token service provider 135, and all provision requests for issuers that use that token service provider 135 have data that is encrypted with the encryption key and signed with the validation key for that token service provider 135. Optionally, multiple issuers may utilize the same encryption key and/or validation key. When the digital issuance gateway 185 obtains an encryption and/or validation key, the encryption and/or validation key may be stored with other keys in a database or other storage location accessible to the digital issuance gateway 185. The digital issuance gateway 185 may search the key database using, for example, the primary account number data. As an example, the first four digits of a sixteen digit account number may identify an issuer, so the database may be queried using the first four digits of the sixteen digit account number from the PAN data to identify the encryption key and/or validation key. As another example, the issuer may be identified based on the PAN data and the database may be queried using the issuer for the encryption key and/or validation key. Optionally, the PAN data encrypted with the encryption key may also be encrypted with the wallet certificate from the wallet data. The wallet certificate may include a public key used for encrypting the PAN data. The pay wallet server 605 may have the corresponding private key for decryption that the pay wallet server may use to decrypt the PAN data as described below.

In some embodiments, the validation key is unique to the point sponsor 115 and the token service provider 135. In other embodiments, the token service provider 135 permits the digital issuance gateway 185 to use the same validation key across multiple point sponsors 115 processed by the digital issuance gateway 185 because the gateway 185 performs mutual authentication with the point sponsor 115, and the token service provider 135 trusts the gateway's 185 authentication of the point sponsor 115. Using the same validation key across multiple point sponsors 115 speeds up the implementation timeline for enabling this gateway 185 service for a new point sponsor 115. The chain of trust generated by the process is sufficient to ensure security. For example, the chain of trust is that the point sponsor 115 authorizes the user and sends the request to the digital issuance gateway 185. The digital issuance gateway 185 has mutual authentication of the point sponsor 115 and signs the request payload with a key trusted by the token service provider 135. Accordingly, because the request is encrypted with a trusted key by a trusted partner that in turn has authenticated the point sponsor 115, and the point sponsor 115 has in turn authenticated the user, the token service provider 135 can be assured that the user is validly requesting the provisioning of the payment source into the user's digital pay wallet 145.

With respect to digital issuance gateway 185, the token service provider 135 and the pay wallet server 605 may each have different encryption requirements. Further, for any given push provision request, any available digital wallet (e.g., pay wallet server 605) and any available token service provider (e.g., token service provider 135) may be used so that any given push provision request may require any combination of encryption requirements that meet both the selected token service provider encryption requirements and the digital wallet encryption requirements. The digital issuance gateway 185 may identify the set of encryption requirements for the token service provider 135 identified by the encryption key. The digital issuance gateway 185 may also identify the set of encryption requirements for the pay wallet server 605 based on the wallet data included with the PAN data. The encryption requirements for all available token service providers 135 may be stored in a database available to digital issuance gateway 185. The encryption requirements for all available pay wallet servers 605 may also be stored in a database available to digital issuance gateway 185. Digital issuance gateway 185 may identify each set of encryption requirements (i.e., the set of encryption requirements for the token service provider 135 and the set of requirements for the pay wallet server 605) and ensure the encryption of the PAN data complies with each set of requirements. Example requirements may include the type of encryption algorithm (e.g., symmetric-key algorithm, format-preserving algorithm, and so forth) that may be used, the minimum length of the encryption key (e.g., 128-bit key, 664-bit key, and so forth) that may be used, and so forth.

Once the digital issuance gateway 185 has generated the encrypted provision data, the digital issuance gateway 185 may transmit the encrypted provision data to the point sponsor 115 as shown by arrow 642. The point sponsor 115 may transmit the encrypted provision data to the point sponsor mobile application 140 as shown by arrow 644. The point sponsor mobile application 140 may invoke an add card method that may call methods within the software development kit 150 as shown by arrow 646.

The software development kit 150 may initiate a request to add the card to the pay wallet 145 by transmitting the encrypted provision data to the pay wallet 145 as shown by arrow 648. The pay wallet may transmit the provision request to the pay wallet server 605 by transmitting the encrypted provision data as shown by arrow 650. The pay wallet server 605 may transmit the provision request and the encrypted provision data to the token service provider 135 as shown by arrow 652.

The token service provider 135 may use the encryption key to decrypt the encrypted provision data and may use the validation key to authenticate the data as from the digital issuance gateway 185. The token service provider 135 may identify within the decrypted provision data the account information including the PAN data (e.g., the sixteen-digit account number), the user information, the wallet data, and so forth, and use the identified information to generate a token to be used by the user within the pay wallet 145. The token service provider 135 may transmit a provision authorization, including the token and the issuer nonce, to the issuing processor gateway 130 as shown by arrow 654.

The issuing processor gateway 130 may store the token with the PAN data. Optionally, the point sponsor mobile application 140 may have previously sent the issuer nonce to the issuing processor gateway 130 (step not depicted in FIG. 6). The issuing processor gateway 130 may check the issuer nonce from the point sponsor mobile application 140 against the issuer nonce received at 654 to confirm that the push provision request was authenticated by the point sponsor 115, thereby validating the chain-of-trust. The issuing processor gateway 130 may transmit an acknowledgement to the token service provider 135 as shown by arrow 656. The token service provider 135 may then transmit a provision notification to the issuing processor gateway 130 as shown by arrow 658, and the issuing processor gateway 130 may transmit an acknowledgement to the token service provider 135 as shown by arrow 660. After these acknowledgements, the token service provider 135 and the issuing processor gateway 130 both acknowledge the token and consider the account provisioned into the pay wallet 145.

The token service provider 135 then transmits the provision response (e.g., successful provisioning indicated by the token, which is also transmitted) to the pay wallet server 605 as shown by arrow 662. The pay wallet server 605 then stores the token with the user information and account information so that future requests to determine whether the add button should be included in the point sponsor mobile application 140 will result in a negative response. Further, the pay wallet 145 will obtain the token from the pay wallet server 605 to allow the user to use the payment source (i.e., account associated with the token) from the pay wallet 145. The pay wallet server 605 transmits the token to the pay wallet 145 as shown by arrow 664. The pay wallet 145 transmits the token and/or a success or failure message indicating whether the payment source was successfully provisioned or not to the software development kit 150 as shown by arrow 666. The software development kit 150 transmits the token and/or the success or failure message to the point sponsor mobile application 140 as shown by arrow 668. The point sponsor mobile application 140 then optionally displays a notification to the user that the account was successfully provisioned into the pay wallet 145 or indicates a failure if the provisioning was unsuccessful.

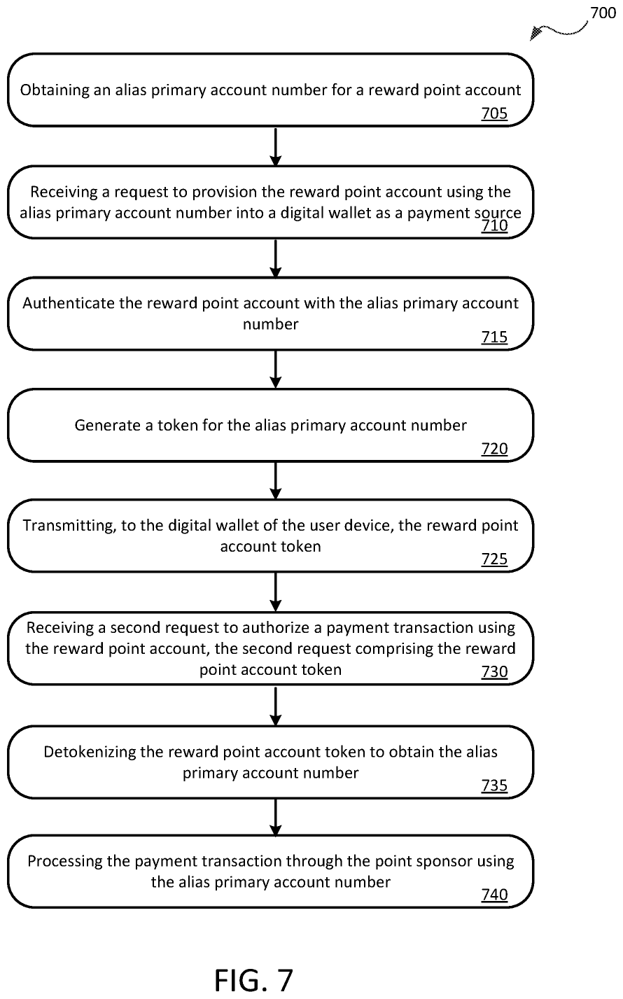

FIG. 7 illustrates a flow diagram of a method 700 for provisioning a reward point account into a digital wallet. The method 700 may be performed by, for example, the token service system 110. Method 700 may begin at block 705 with obtaining an alias primary account number for a reward point account as described with respect to FIGS. 1 and 2. The alias primary account number may be generated based on the token BIN sponsor as described with respect to FIG. 2. The alias primary account number may be generated by the points bank and obtained by the token service system. In some embodiments, the card management system may generate the alias primary account number. At block 710, the token service system may receive a request to provision the reward point account into the digital wallet (e.g., pay wallet 145) of a user device (e.g., wallet device 105). The token service system may receive the request from the digital wallet. The token service provider may authenticate the reward point account with the alias primary account number at block 715. As described with respect to FIG. 3, the token service provider may send the authentication request to the points bank via the issuer processor gateway, and receive the authorization in response. At block 720, the token service provider may tokenize the alias primary account number to generate a reward point account token. The token may be generated based on the payment network (e.g., payment network 125) used to process payments using the reward point account as the payment source. At block 725, the token service system may transmit the reward point account token to the digital wallet of the user device, and the digital wallet may use the reward point account token to display the reward point account as a payment source in the digital wallet.

At block 730, the token service system may receive a second request. The second request may include the reward point account token and request authorization of the reward point account to fund payment of a transaction at a merchant. The token service system may detokenize the reward point account token to obtain the alias PAN at block 735. At block 740, the token service system may process the payment using the alias PAN by requesting authorization from the issuer processor, which can obtain validation from the points bank as described in detail with respect to FIGS. 4 and 5.

FIG. 8 illustrates an embodiment of a computer system 800. A computer system 800 as illustrated in FIG. 8 may be incorporated into devices such as a personal computer, server computer, mobile device (e.g., smartphone, smart watch, tablet, and the like), point of service (“POS”) terminal, and the like. FIG. 8 provides a schematic illustration of one embodiment of a computer system 800 that can perform some or all of the steps of the methods provided by various embodiments. It should be noted that FIG. 8 is meant only to provide a generalized illustration of various components, any or all of which may be utilized as appropriate. FIG. 8, therefore, broadly illustrates how individual system elements may be implemented in a relatively separated or relatively more integrated manner.

The computer system 800 is shown comprising hardware elements that can be electrically coupled via a bus 805, or may otherwise be in communication, as appropriate. The hardware elements may include one or more processors 810, including without limitation one or more general-purpose processors and/or one or more special-purpose processors such as digital signal processing chips, graphics acceleration processors, and/or the like; one or more input devices 815, which can include without limitation a mouse, a keyboard, a camera, a remote control, and/or the like; and one or more output devices 820, which can include without limitation a display device, a printer, and/or the like.

The computer system 800 may further include and/or be in communication with one or more non-transitory storage devices 825, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 800 might also include a communications subsystem 830, which can include without limitation a modem, a network card (wireless or wired), an infrared communication device, a wireless communication device, and/or a chipset such as a Bluetooth® device, an 802.11 device, a Wi-Fi device, a WiMax device, cellular communication facilities, etc., and/or the like. The communications subsystem 830 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate transaction and/or other information via the communications subsystem 830. In other embodiments, a portable electronic device, may be incorporated into the computer system 800 (e.g., an electronic device), as an input device 815. In many embodiments, the computer system 800 will further comprise a working memory 835, which can include a RAM or ROM device, as described above.

The computer system 800 also can include software elements, shown as being currently located within the working memory 835, including an operating system 840, device drivers, executable libraries, and/or other code, such as one or more application programs 845, which may comprise computer programs provided by various embodiments, and/or may be designed to implement methods, and/or configure systems, provided by other embodiments, as described herein. Merely by way of example, one or more procedures described with respect to the methods discussed above, such as those described in relation to FIG. 7, might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code might be stored on a non-transitory computer-readable storage medium, such as the storage device(s) 825 described above. In some cases, the storage medium might be incorporated within a computer system, such as computer system 800. In other embodiments, the storage medium might be separate from a computer system (e.g., a removable medium), such as a compact disc, and/or provided in an installation package, such that the storage medium can be used to program, configure, and/or adapt a general purpose computer with the instructions/code stored thereon. These instructions might take the form of executable code, which is executable by the computer system 800 and/or might take the form of source and/or installable code, which, upon compilation and/or installation on the computer system 800 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 800 to perform methods in accordance with various embodiments of the technology. According to a set of embodiments, some or all of the procedures of such methods are performed by the computer system 800 in response to processor 810 executing one or more sequences of one or more instructions, which might be incorporated into the operating system 840 and/or other code, such as an application program 445, contained in the working memory 835. Such instructions may be read into the working memory 835 from another computer-readable medium, such as one or more of the storage device(s) 825. Merely by way of example, execution of the sequences of instructions contained in the working memory 835 might cause the processor(s) 810 to perform one or more procedures of the methods described herein. Additionally or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 800, various computer-readable media might be involved in providing instructions/code to processor(s) 810 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 825. Volatile media include, without limitation, dynamic memory, such as the working memory 835.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 810 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 800.

The communications subsystem 830 and/or components thereof generally will receive signals, and the bus 805 then might carry the signals and/or the data, instructions, etc. carried by the signals to the working memory 835, from which the processor(s) 810 retrieves and executes the instructions. The instructions received by the working memory 835 may optionally be stored on a non-transitory storage device 825 either before or after execution by the processor(s) 810.

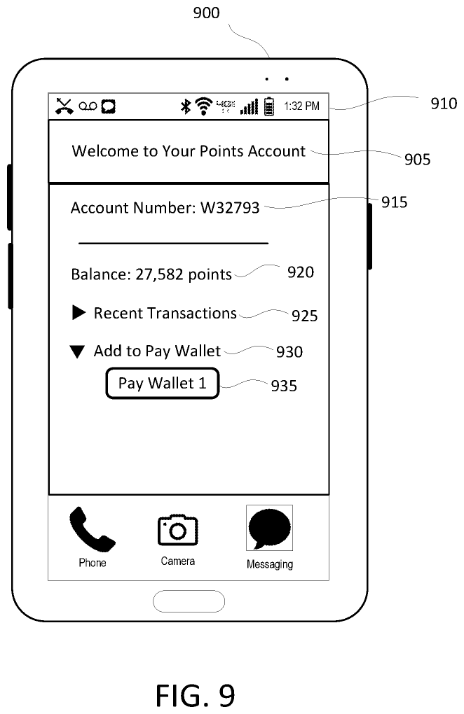

FIG. 9 illustrates an exemplary mobile device 900 (e.g., wallet device 105) which is displaying a user interface of the point sponsor mobile application (e.g., point sponsor mobile application 140). The mobile device has a system header 910, which is standard for most mobile devices. The reward point account number (“W32793”) is displayed as shown at 915. A balance 920, for example, may be shown in the user interface. A collapsible link 925 for recent transactions may be available. Further, a collapsible link 930 for adding an account to a pay wallet may be available. Once the collapsible link 930 is selected, the button 935 for provisioning the reward point account, which has an associated account number of W32793, into Pay Wallet 1. The button 935 may be provided as a result of the actions described with respect to FIGS. 1 and 2. If the user selects the button 935 to initiate the provisioning process, the provisioning process will commence to request provisioning of the reward point account, which will result in an alias PAN and a reward point account token, which will be used to make the reward point account available for use on the mobile device 900 within Pay Wallet 1.

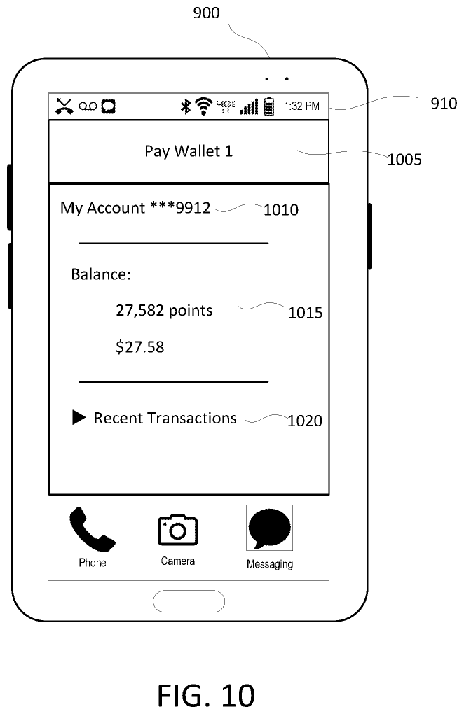

FIG. 10 illustrates the exemplary mobile device 900, which is now displaying the provisioned reward point account in Pay Wallet 1. Pay Wallet 1 is displayed as shown at 1005. The reward point account now has a nickname “My Account” and an alias PAN ending in “9912,” which is displayed at 1010. The balance of the reward point account is displayed both as points and as a monetary value as converted by the points bank at 1015. A collapsible link 1020 for recent transactions may be available. Using the user interface of Pay Wallet 1 1005, the user can now use the reward point account, provisioned with an alias PAN ending in 9912 for payment of goods and services up to the available balance of $27.58 as shown at 1015.

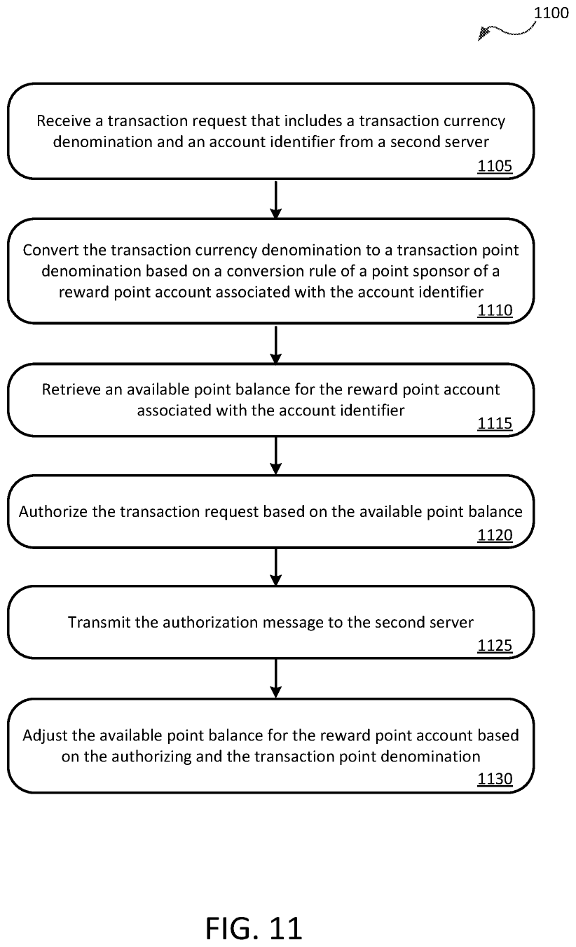

FIG. 11 illustrates flow diagram of a method 1100 for real-time transaction conversion. The method 1100 may be performed by, for example, the points bank 120 or the points bank aggregator gateway 505. Method 1100 may begin at block 1105 with a points bank or aggregator receiving a transaction request that includes a transaction currency denomination and an account identifier from a second server. For example, a customer may use his pay wallet in a store with the provisioned reward point account to pay for an item. To process the transaction, the issuer processor gateway can send a transaction request to the points bank or to the aggregator for the transaction amount. The transaction amount will be a currency denomination (e.g., $10) and include an account identifier of the reward point account.

At block 1110, the points bank or aggregator will convert the transaction currency denomination to a transaction point denomination based on a conversion rule of the point sponsor the reward point account. The conversion rule may be, for example, that each point is worth ten cents. The conversion rule is determined by the point sponsor and provided to the aggregator and/or the points bank for converting each transaction at the time of the transaction.

At block 1115, the points bank or aggregator will retrieve an available point balance for the reward point account associated with the account identifier. The points bank maintains the points balance for each account, and for each transaction the points balance available for the reward point account is checked to ensure sufficient points are available. The available points are converted to a currency denomination based on the conversion rule, and the available currency denomination of the reward point account is compared to the transaction currency amount needed to complete the transaction. In some embodiments, the aggregator or points bank may use the currency denomination to determine available funds, and in some embodiments the aggregator or points bank may use the points denomination to determine the available funds. Accordingly, alternatively, the transaction point denomination is compared to the available points in the reward point account to determine if there are sufficient points to complete the transaction.

At block 1120, the points bank or aggregator will authorize the transaction request based on the available point balance. If there are enough points available in the reward point account to cover the entire transaction point denomination, the transaction is approved and an approval message is generated. If there are not enough points available in the reward point account to cover the entire transaction point denomination, the transaction may be declined and a decline message may be generated. In some embodiments, if there are not enough points available in the reward point account to cover the entire transaction point denomination, a partial approval may be generated.

At block 1125, the points bank or aggregator will transmit the authorization message to the second server. The authorization message is an approval message, a decline message, or a partial approval message based on the determination at block 1120.

At block 1130, the points bank or aggregator will adjust the available point balance for the reward point account based on the authorizing and the transaction point denomination. For example, if the transaction was approved, the reward point account may be reduced by the transaction point denomination. If the transaction was declined, the reward point account balance may be maintained. If the transaction was partially approved, the reward point account balance is reduced by the partial amount that was approved. The partial approval will have a point value and a currency value. The currency value is provided in the authorization message to the second server, and the point value, calculated using the conversion rule applied to the currency value, is used to reduce the available point balance. The points bank maintains the points balance at all times, and a hold may be placed on the transaction point value in the reward account at the points bank for the approved amount. When the payment network settles the transaction, the reward point account deduction will be complete. In some embodiments, the aggregator will approve the transaction and send a message to the points bank with the instruction to adjust the available points balance for the reward point account so that the points bank always has accurate values for available points balances for all reward point accounts maintained by the points bank. In this way, the real-time conversion and update of the reward points ensures the user can access the points of his or her reward point account at any time via any method because the source of the reward point account balance is always up-to-date.

While a sale transaction is described in method 1100, the transaction may be a balance inquiry, a return transaction, or any other transaction. In any transaction, the points balance information is obtained from the points bank at the time of the transaction. When an aggregator is used, the aggregator updates the points bank and requests the points balance for the reward point account during the transaction such that the transaction happens in real-time much like a credit or debit card transaction.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

As used herein and in the appended claims, the singular forms “a”, “an”, and “the” include plural references unless the context clearly dictates otherwise. Thus, for example, reference to “a user” includes a plurality of such users, and reference to “the processor” includes reference to one or more processors and equivalents thereof known to those skilled in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

1. A method, comprising:
receiving, by a first server from a second server, a transaction request comprising a transaction currency denomination and an account identifier;
converting, by the first server, the transaction currency denomination to a transaction point denomination based on a conversion rule of a point sponsor of a reward point account associated with the account identifier;
retrieving, by the first server, an available point balance for the reward point account associated with the account identifier;
authorizing, by the first server, the transaction request based on the available point balance;
transmitting, by the first server, an authorization message to the second server; and
adjusting, by the first server, the available point balance for the reward point account based on the authorizing and the transaction point denomination.

2. The method of claim 1, wherein the first server is operated by a points bank for maintaining reward point accounts for the point sponsor.

3. The method of claim 1, wherein the first server is operated by a points aggregator, and wherein adjusting the available point balance for the reward point account comprises:
transmitting, by the first server, a point balance update message to a third server, wherein the point balance update message comprises instructions to adjust the available point balance for the reward point account based on the transaction point denomination, and wherein the third server is operated by a points bank for maintaining reward point accounts for the point sponsor.

4. The method of claim 1, wherein the second server is a gateway of a payment network.

5. The method of claim 1, wherein the transaction request is a real-time transaction request for a point-of-sale transaction.

6. The method of claim 1, wherein the first server is an aggregator server for a plurality of point sponsors, each point sponsor having one or more conversion rules of the plurality of conversion rules.

7. The method of claim 1, wherein authorizing the transaction request based on the available point balance comprises:
determining that the available point balance is greater than the transaction point denomination;
generating the authorization message to approve the transaction request; and
wherein the adjusting the available balance for the reward point account comprises reducing the available balance for the reward point account by the transaction point denomination.

8. The method of claim 1, wherein authorizing the transaction request based on the available point balance comprises:
determining that the available point balance is less than the transaction point denomination;
generating the authorization message to decline the transaction request; and
wherein the adjusting the available balance for the reward point account based on the authorizing comprises maintaining the available point balance based on declining the transaction request.

9. The method of claim 1, wherein authorizing the transaction request based on the available point balance comprises:
determining that the available point balance is less than the transaction point denomination;
converting at least a portion of the available point balance to a second currency denomination based on the conversion rule;
generating the authorization message to approve the second currency denomination of the transaction request; and
wherein the adjusting the available balance for the reward point account based on the authorizing comprises reducing the available point balance by the at least the portion of the available point balance.

10. The method of claim 1, wherein retrieving the available point balance comprises requesting the available point balance from a point bank of the point sponsor.

11. A system, comprising:
one or more processors; and
a memory having stored thereon instructions that, when executed by the one or more processors, cause the one or more processors to:
receive, from a second system, a transaction request comprising a transaction currency denomination and an account identifier;
convert the transaction currency denomination to a transaction point denomination based on a conversion rule of a point sponsor of a reward point account associated with the account identifier;
retrieve an available point balance for the reward point account associated with the account identifier;
authorize the transaction request based on the available point balance;
transmit an authorization message to the second server; and
adjust the available point balance for the reward point account based on the authorizing and the transaction point denomination.

12. The system of claim 11, wherein the system is a points bank for maintaining reward point accounts for a plurality of point sponsors.

13. The system of claim 11, wherein the instructions for adjusting the available point balance for the reward point account comprises instructions that, when executed by the one or more processors, cause the one or more processors to:
transmit a point balance update message to a third system, wherein the point balance update message comprises instructions to adjust the available point balance for the reward point account based on the transaction point denomination, and wherein the third system is operated by a points bank for maintaining reward point accounts for the point sponsor.

14. The system of claim 11, wherein the second system is a gateway of a payment network.

15. The system of claim 11, wherein the transaction request is a real-time transaction request for a point-of-sale transaction.

16. The system of claim 11, wherein the system is an aggregator system for a plurality of point sponsors, each point sponsor having one or more conversion rules of the plurality of conversion rules.

17. The system of claim 11, wherein the instructions to authorize the transaction request based on the available point balance comprises instructions that, when executed by the one or more processors, cause the one or more processors to:
determine that the available point balance is greater than the transaction point denomination;
generate the authorization message to approve the transaction request; and
wherein the instructions for adjusting the available balance for the reward point account comprises instructions that, when executed by the one or more processors, cause the one or more processors to reduce the available balance for the reward point account by the transaction point denomination.

18. The system of claim 11, wherein the instructions to authorize the transaction request based on the available point balance comprises instructions that, when executed by the one or more processors, cause the one or more processors to:
determine that the available point balance is less than the transaction point denomination;
generate the authorization message to decline the transaction request; and
wherein the instructions for adjusting the available balance for the reward point account comprises instructions that, when executed by the one or more processors, cause the one or more processors to maintain the available point balance based on declining the transaction request.

19. The system of claim 11, wherein the instructions to authorize the transaction request based on the available point balance comprises instructions that, when executed by the one or more processors, cause the one or more processors to:
determine that the available point balance is less than the transaction point denomination;
convert at least a portion of the available point balance to a second currency denomination based on the conversion rule;
generate the authorization message to approve the second currency denomination of the transaction request; and
wherein the instructions for adjusting the available balance for the reward point account comprises instructions that, when executed by the one or more processors, cause the one or more processors to reduce the available point balance by the at least the portion of the available point balance.

20. The system of claim 11, wherein retrieving the available point balance comprises requesting the available point balance from a point bank of the point sponsor.
